(19) United States
(12) Patent Application Publication
(10) Pub. No.: US 2013/0024547 A1
(43) Pub. Date: Jan. 24, 2013

(54) INFORMATION PROCESSING APPARATUS, INFORMATION PROCESSING SYSTEM, INFORMATION PROCESSING METHOD, AND PROGRAM

(71) Applicants: Katsu SAITO, Saitama (JP); Masaaki Isozaki, Kanagawa (JP); Kazuo Ishii, Tokyo (JP); Wataru Onogi, Kanagawa (JP); Yoshikazu Takahashi, Saitama (JP)

(72) Inventors: Katsu SAITO, Saitama (JP); Masaaki Isozaki, Kanagawa (JP); Kazuo Ishii, Tokyo (JP); Wataru Onogi, Kanagawa (JP); Yoshikazu Takahashi, Saitama (JP)

(21) Appl. No.: 13/549,956

(22) Filed: Jul. 16, 2012

(30) Foreign Application Priority Data
Jul. 21, 2011 (JP) 2011-159543

(51) Int. Cl. G06F 17/00; G06F 17/30; G06F 15/16

(52) U.S. Cl. 709/219; 707/705; 707/E17.005

(57) ABSTRACT

There is provided an information processing apparatus including an acquisition unit acquiring information showing at least one of an indicated party, who is a person or group indicated by a user, and indicated content, which is content indicated by the user, and a recommendation unit recommending, to the user, content that is similar to at least one of content related to the indicated party, the indicated content, and content liked by the user.

### BACKGROUND

The present disclosure relates to an information processing apparatus, an information processing system, an information processing method, and a program, and in particular to an information processing apparatus, an information processing system, an information processing method, and a program that are favorably used when recommending content.

In the past, a technology for providing user evaluations of songs to a system, generating a taste vector for each user, and providing song lists in keeping with each user's taste based on the similarity between such taste vectors and characteristic vectors of individual songs has been proposed (see, for example, WO2011007631). By using such technology, it is possible for users to passively enjoy songs that match their tastes without having to search through a huge list of songs by themselves.

### SUMMARY

However, with the invention disclosed in the cited publication, even if a user wishes to listen to songs by an artist who differs to the user's usual taste, it is not possible at all times to provide the user with songs by such artist. For example, if a user who usually likes to listen to jazz wishes to listen to songs by an artist who is categorized as rock, should the user request songs by such artist, the song list will be generated based on a taste vector that reflects the user's historic taste. Accordingly, in some cases songs by the artist requested by the user may not be included in the song list, or may not be placed at or near the top of the song list.

The present disclosure aims to provide content in keeping with a user request.

According to an first embodiment of the present disclosure, there is provided a device which includes an information processing apparatus including an acquisition unit acquiring information showing at least one of an indicated party, who is a person or group indicated by a user, and indicated content, which is content indicated by the user, and a recommendation unit recommending, to the user, content that is similar to at least one of content related to the indicated party, the indicated content, and content liked by the user.

The information processing apparatus may further include a vector combining unit generating a combined vector by combining an indicated characteristic vector, which is a characteristic vector showing characteristics of the content related to the indicated party or the indicated content, and a user taste vector, which shows characteristics of the content liked by the user. The recommendation unit may recommend, to the user, content whose characteristic vector is similar to the combined vector.

The vector combining unit may combine the indicated characteristic vector and the user taste vector using a ratio indicated by the user.

The information processing apparatus may further include a display control unit controlling display of a setting screen which displays, when the user has made a total of at least two indications of indicated parties and/or indicated content, display respectively corresponding to the indicated parties and/or the indicated content and a display corresponding to the user at specified display positions and which sets a ratio for use when combining the indicated characteristic vector and the user taste vector, based on distances from the respective display positions to a position indicated by the user.

The information processing apparatus may further include a display control unit operable, when the indicated party has been indicated, to carry out control to display a name of the indicated party in a setting screen setting the ratio for use when combining the indicated characteristic vector and the user taste vector. The vector combining unit may combine the indicated characteristic vector showing the characteristics of the content related to the indicated party and the user taste vector using the ratio set in the setting screen.

The information processing apparatus may further include an indicated characteristic vector generating unit generating the indicated characteristic vector; and a user taste vector generating unit generating the user taste vector.

The information processing apparatus may further include a representative work extracting unit extracting a representative work out of the content related to the indicated party based on at least one of the number of multiple registrations of content and user evaluations of content. The indicated characteristic vector generating unit may generate the indicated characteristic vector for the indicated party based on a characteristic vector of the extracted representative work.

The recommendation unit may generate a list of content recommended to the user and set an order of content in the list based on similarity between the combined vector and respective characteristic vectors of the content.

The recommendation unit may generate a list of content recommended to the user, and the information processing apparatus may further include a representative work extracting unit extracting a representative work out of content related to one of the indicated party and a person or group related to the indicated content, based on at least one of the number of multiple registrations of content and user evaluations of content, and a representative work inserting unit inserting the extracted representative work at or near the top of the list.

The representative work extracting unit may extract the representative work separately for specified regions.

The information processing method carried out by the information processing apparatus that recommends content, may include acquiring information showing at least one of an indicated party, who is a person or group indicated by a user, and indicated content, which is content indicated by the user, and recommending, to the user, content that is similar to at least one of content related to the indicated party, the indicated content, and content liked by the user.

According to the first embodiment of the present disclosure, a program causing a computer to execute processing may include acquiring information showing at least one of an indicated party, who is a person or group indicated by a user, and indicated content, which is content indicated by the user, and recommending, to the user, content that is similar to at least one of content related to the indicated party, the indicated content, and content liked by the user.

According to a second embodiment of the present disclosure, there is provided an information processing system including a server and a client. The client may include a transmission unit transmitting information showing at least one of an indicated party, who is a person or group indicated by a user, and indicated content, which is content indicated by the user, and the server may include or group indicated by a user, and indicated content, which is content indicated by the user is acquired and content that is similar to at least one of content related to the indicated party, the indicated content, and content liked by the user is recommended to the user.

According to the second embodiment of the present disclosure, there is provided an information processing method including a client transmitting information showing at least one of an indicated party, who is a person or group indicated by a user, and indicated content, which is content indicated by the user, and a server receiving the information transmitted from the client and recommending, to the user, content that is similar to at least one of content related to the indicated party, the indicated content, and content liked by the user.

According to the first embodiment of the present disclosure, information showing at least one of an indicated party, who is a person or group indicated by a user, and indicated content, which is content indicated by the user is acquired and content that is similar to at least one of content related to the indicated party, the indicated content, and content liked by the user is recommended to the user.

According to the second embodiment of the present disclosure, information showing at least one of an indicated party, who is a person or group indicated by a user, and indicated content, which is content indicated by the user is transmitted by a client to a server, the information transmitted from the client is received by the server, and content that is similar to at least one of content related to the indicated party, the indicated content, and content liked by the user is recommended by the server to the user.

According to the first and second embodiments of the present disclosure described above, it is possible to provide content in keeping with a user request.

### BRIEF DESCRIPTION OF THE DRAWINGS

FIG. 1 is a diagram showing the overall configuration of a content recommendation system according to an embodiment of the present disclosure;

FIG. 2 is a diagram showing the hardware configuration of a server;

FIG. 3 is a diagram showing the hardware configuration of a user apparatus;

FIG. 4 is a perspective view showing the external appearance of a user apparatus;

FIG. 5 is a perspective view showing the external appearance of a user apparatus according to a modification;

FIG. 6 is a functional block diagram of a user apparatus;

FIG. 7 is a functional block diagram of a song distributing server;

FIG. 8 is a diagram schematically showing an example data structure of a user attribute database;

FIG. 9 is a diagram schematically showing an example data structure of a song information database;

FIG. 10 is a diagram schematically showing an example data structure of a song characteristic database;

FIG. 11 is a diagram schematically showing an example data structure of a song attribute database;

FIG. 12 is a diagram schematically showing an example data structure of a user evaluation database;

FIG. 13 is a diagram schematically showing an example data structure of a song evaluation database;

FIG. 14 is a functional block diagram of a recommendation unit;

FIG. 15 is a diagram showing the stored content of an internal ranking storage unit;

FIG. 16 is a flowchart useful in explaining a representative song extracting process;

FIG. 17 is a flowchart useful in explaining a song recommendation process;

FIG. 18 is a diagram showing a first example of a setting screen for setting a recommendation ratio;

FIG. 19 is a diagram showing a second example of a setting screen for setting a recommendation ratio;

FIG. 20 is a flowchart useful in explaining a recommended song list generating process; and

FIG. 21 is a diagram showing an example of a first list.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Preferred embodiments of the present disclosure are described in the order indicated below.

### 1. Embodiments

### 2. Modifications

### 1. First Embodiment

### Example Configuration of Content Recommendation System 10

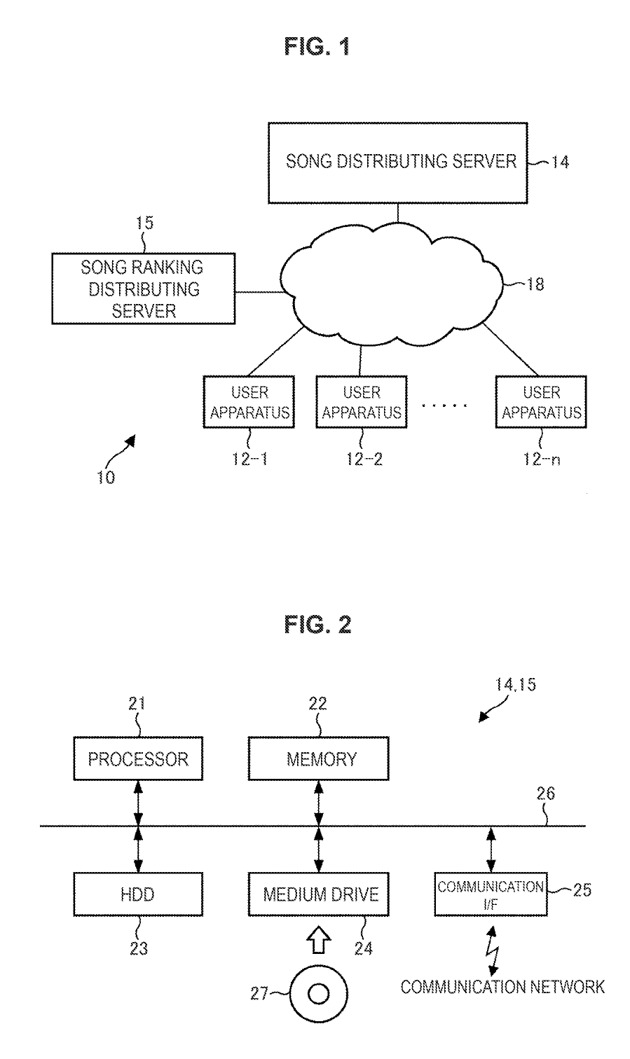

FIG. 1 is a diagram showing the overall configuration of a content recommendation system 10 according to an embodiment of the present disclosure.

The content recommendation system 10 includes a song distributing server 14, a song ranking distributing server 15, and a plurality of user apparatuses 12-1 to 12-n as clients. All of such apparatuses are connected to a communication network 18, such as the Internet, and are capable of data communication with one another.

Note that in the following description, when it is not necessary to distinguish between the user apparatuses 12-1 to 12-n, such apparatuses are collectively referred to as the “user apparatus 12”.

As examples, the user apparatus 12 is constructed of a computer system such as a personal computer, a computer game system, or a home server set up in the home, or a portable computer system, such as a mobile game console or a mobile phone. Each user apparatus 12 accesses the song distributing server 14 and receives a list (hereinafter referred to as a “recommended song list”) of songs recommended to the user of that particular user apparatus 12. Each user apparatus 12 also requests the data of a song included in the recommended song list from the song distributing server 14, and receives and reproduces such data.

Meanwhile, the song distributing server 14 is constructed of a computer system or the like, such as a well-known server computer. The song distributing server 14 transmits a list (“recommended song list”) of songs recommended to the user of a particular user apparatus 12 to such user apparatus 12. The song distributing server 14 also transmits data of individual songs in accordance with requests from the respective user apparatuses 12.

As one example, the song ranking distributing server 15 is also constructed of a computer system or the like, such as a well-known server computer. The song ranking distributing server 15 is managed by a different administrator to the song distributing server 14 and transmits song rankings in response to requests from the song distributing server 14.

As one example, such song rankings are regularly issued (for example, every week or every month) on a country-by-country basis for individual music genres such as pop, jazz, and classical, and are stored in association with the issue date and music genre in the song distributing server 14. Note that such rankings may be generated from a variety of viewpoints, and as one example may be based on number of sales, number of downloads, and/or number of views of song-related information (for example, a song description).

### Example Configurations of Song Distributing Server 14 and Song Ranking Distributing Server 15

FIG. 2 is a diagram showing example hardware configurations of the song distributing server 14 and the song ranking distributing server 15.

The song distributing server 14 and/or the song ranking distributing server 15 include a processor 21, a memory 22, a hard disk drive 23, a medium drive 24, and a communication interface (I/F) 25, with such component elements being connected to a bus 26 so as to be capable of exchanging data with each other.

The processor 21 controls the various component elements of the server in accordance with a program stored in the memory 22, the hard disk drive 23, or a computer-readable medium 27.

The memory 22 is composed of ROM and RAM, for example, with various system programs being stored in the ROM and the RAM mainly being used as a workspace of the processor 21.

The hard disk drive 23 stores a program for distributing songs and/or distributing song rankings and constructs various databases for distributing songs and/or distributing song rankings.

The medium drive 24 is an apparatus that reads data stored on the computer-readable medium 27, which is a CD-ROM, a DVD-RAM, or the like, and/or writes data onto the computer-readable medium 27.

The communication interface 25 controls data communication via the communication network 18 with another computer system such as a user apparatus 12.

### Example Configuration of User Apparatus 12

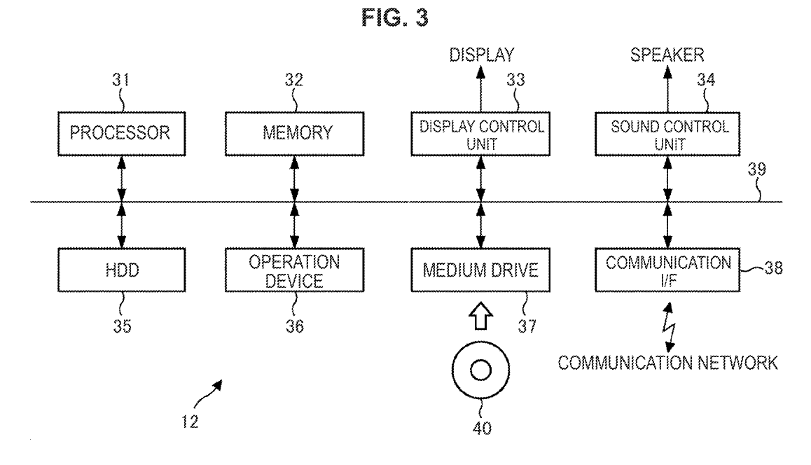

FIG. 3 is a diagram showing an example hardware configuration of the user apparatus 12.

The user apparatus 12 includes a processor 31, a memory 32, a display control unit 33, a sound control unit 34, a hard disk drive 35, an operation device 36, a medium drive 37, and a communication interface (I/F) 38, with such component elements being connected to a bus 39 so as to be capable of exchanging data with each other.

The processor 31 controls the various component elements of the user apparatus 12 in accordance with a program stored in the memory 32, the hard disk drive 35, or a computer-readable medium 40.

The memory 32 is composed of ROM and RAM, for example, with various system programs being stored in the ROM and the RAM mainly being used as a workspace of the processor 31.

The display control unit 33 includes a video memory, converts images drawn in the video memory by the processor 31 to a video signal, and outputs the video signal to a display to have the images displayed.

The sound control unit 34 includes a sound buffer and converts sound data stored in the sound buffer by the processor 31 to an analog audio signal and outputs the analog audio signal to speakers to have sound outputted.

The hard disk drive 35 stores various programs such as a song reproduction program and constructs various databases.

The operation device 36 is used for example by the user to give various instructions to the user apparatus 12 and to input data, and as examples is constructed of a keyboard, a pointing device such as a mouse, or a game pad.

The medium drive 37 is an apparatus that reads data stored on the computer-readable medium 40, which is a CD-ROM, a DVD-RAM, or the like, and/or writes data onto the computer-readable medium 40.

The communication interface 38 controls data communication via the communication network 18 with another computer system such as the song distributing server 14.

### Specific Example of User Apparatus 12

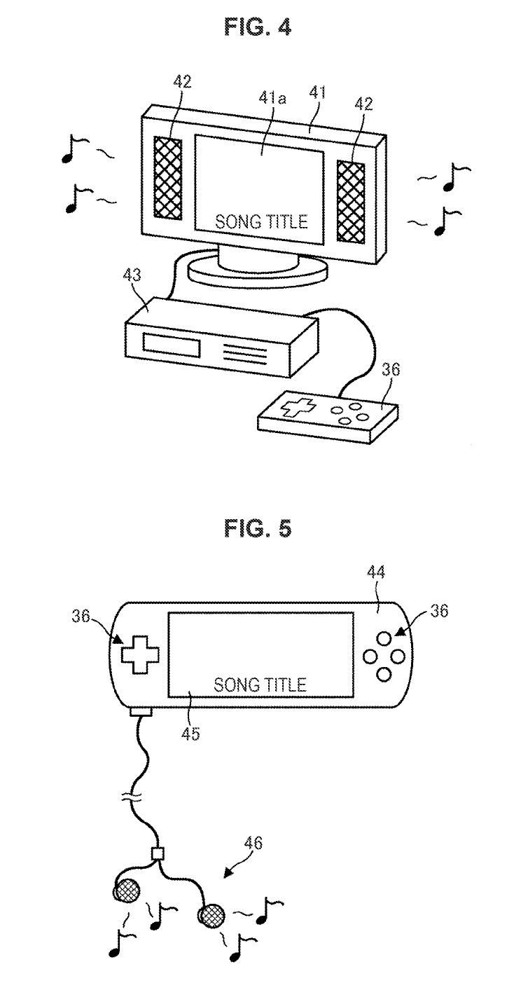

The user apparatus 12 can be realized in a variety of forms, and one example configuration shown in FIG. 4 is a home game console that operates off a domestic power supply

In this case, the hardware elements shown in FIG. 3 are housed in a case 43 and a display 41a and speakers 42, 42 of a television set 41 that is separate to the case 43 are used as the display and speakers. The operation device 36 is also provided separately to the case 43.

As an alternative, the user apparatus 12 can be configured as shown in FIG. 5 as a portable all-in-one game console that operates off batteries.

In this case, the hardware elements shown in FIG. 3 are housed in a case 44 and a flat panel display 45 provided on the surface of the case 44 is used as the display. The operation device 36 is also provided on the surface of the case 44 and as one example is disposed on the left and right of the flat panel display 45. As the speakers, speakers, not shown, incorporated in the case 44 may be used, as may be stereo headphones 46 that are separate to the case 44.

### Example of Functional Configuration of User Apparatus 12

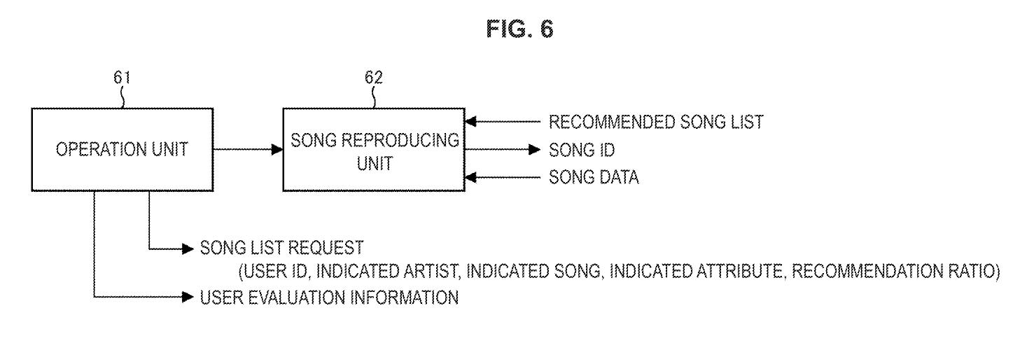

Here, the functional configuration of a user apparatus 12 will be described. FIG. 6 is a functional block diagram of the user apparatus 12.

The user apparatus 12 functionally includes an operation unit 61 and a song reproducing unit 62. As one example, such functional elements are realized by a program executed in the user apparatus 12.

The operation unit 61 is configured so as to be centered on the operation device 36, and when a specified request operation has been carried out on the operation device 36, a request for a recommended song list (hereinafter referred to as a “song list request”) is transmitted via the communication interface 38 to the song distributing server 14. The song list request includes a user ID that is identification information of the user, an artist (hereinafter simply “indicated artist”), a song (hereinafter simply “indicated song”), and an attribute (hereinafter simply “indicated attribute”) indicated by the user, and a recommendation ratio, described later.

If the user has inputted an evaluation for a song using the operation device 36, the operation unit 61 transmits user evaluation information including a song ID that is identification information for the song being evaluated, the user ID of the user making the evaluation, and the inputted evaluation via the communication interface 38. As examples, it is possible for the user to provide a positive evaluation (for example, “like”), a negative evaluation (for example, “dislike”) or an evaluation value (for example, evaluation on five levels or a points score) to each song.

The operation unit 61 also determines a user evaluation of a song based on a user operation (as examples, skipping or stopping) carried out on the operation device 36 during reproduction of the song and the reproduced state of the song (as one example, whether the song was reproduced to the end). The operation unit 61 then transmits user evaluation information including the determined evaluation via the communication interface 38.

In addition, if a user operation has been carried out for the operation device 36, the operation unit 61 may notify the song reproducing unit 62 of such operation as necessary.

The song reproducing unit 62 receives the recommended song list transmitted from the song distributing server 14 via the communication network 18 and the communication interface 38. In addition, the song reproducing unit 62 transmits the song ID of each song included in the recommended song list in order of the list via the communication interface 38 to the song distributing server 14. The song reproducing unit 62 receives song data transmitted from the song distributing server 14 in reply to transmission of a song ID via the communication network 18 and the communication interface 38 and reproduces the song data using the sound control unit 34. At this time, as shown in FIGS. 4 and 5, the song reproducing unit 62 displays the title of the song included in the song data on the display. The song reproducing unit 62 also controls reproduction of the song data in accordance with user operations of the operation device 36.

### Example of Functional Configuration of Song Distributing Server 14

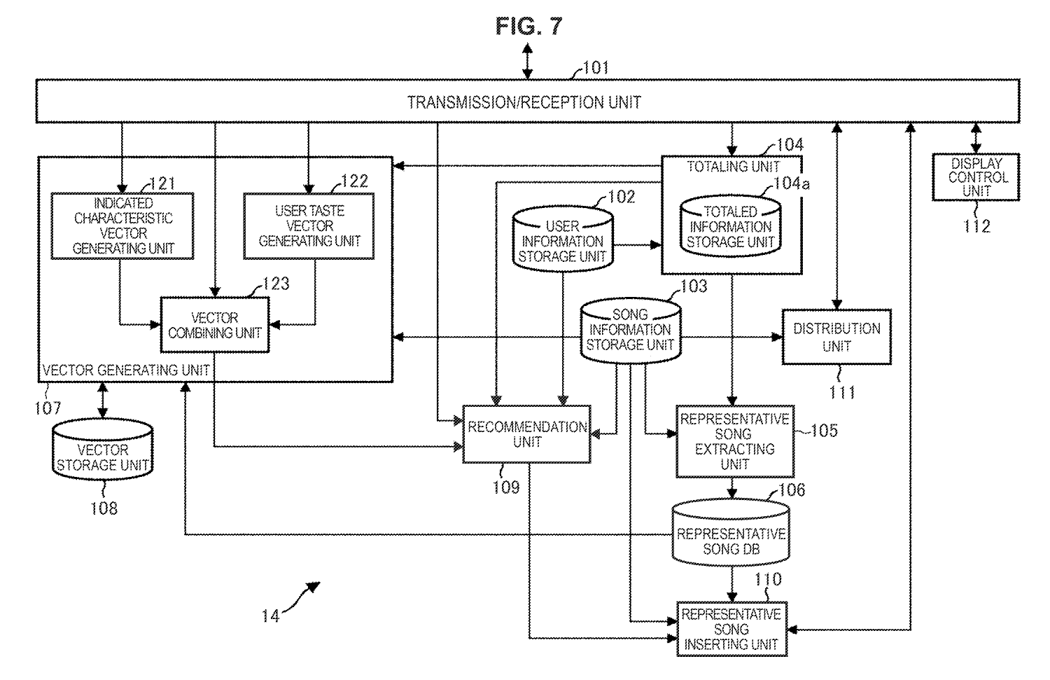

Next, the functional configuration of the song distributing server 14 will be described. FIG. 7 is a functional block diagram of the song distributing server 14.

In functional terms, the song distributing server 14 includes a transmission/reception unit 101, a user information storage unit 102, a song information storage unit 103, a totaling unit 104, a representative song extracting unit 105, a representative song database 106, a vector generating unit 107, a vector storage unit 108, a recommendation unit 109, a representative song inserting unit 110, a distribution unit 111, and a display control unit 112. The vector generating unit 107 includes an indicated characteristic vector generating unit 121, a user taste vector generating unit 122, and a vector combining unit 123. As one example, such functional elements are realized by a program being executed in the song distributing server 14.

The transmission/reception unit 101 is configured so as to be centered on the communication interface 25 and carries out data communication via the communication network 18 with another computer system such as a user apparatus 12. The transmission/reception unit 101 supplies received data to the various units of the song distributing server 14 and transmits data acquired from the various units of the song distributing server 14 to another computer system.

As one example, the transmission/reception unit 101 receives the user evaluation information transmitted from the respective user apparatuses 12 and supplies the user evaluation information to the totaling unit 104. The transmission/reception unit 101 also receives song rankings from the song ranking distributing server 15 and supplies the song rankings to the recommendation unit 109.

In addition, the transmission/reception unit 101 receives song list requests transmitted from the respective user apparatuses. The transmission/reception unit 101 then notifies the indicated characteristic vector generating unit 121 of the indicated artist and the indicated song included in a song list request and requests generation of an indicated characteristic vector. The transmission/reception unit 101 also notifies the user taste vector generating unit 122 of the user ID included in a song list request and requests generation of a user taste vector. In addition, the transmission/reception unit 101 notifies the vector combining unit 123 of the recommendation ratio included in the song list request. The transmission/reception unit 101 notifies the recommendation unit 109 of the user ID and the indicated attribute included in the song list request and requests generation of a recommended song list. In addition, the transmission/reception unit 101 notifies the representative song inserting unit 110 of the indicated artist and the indicated song included in the song list request.

The transmission/reception unit 101 transmits the recommended song list supplied from the representative song inserting unit 110 to the user apparatus 12 that issued the request. In addition, the transmission/reception unit 101 notifies the totaling unit 104 of the song IDs included in the recommended song list and the user ID of the recipient of the recommended song list.

The transmission/reception unit 101 receives a song ID transmitted from the user apparatus 12 and supplies the song ID to the distribution unit 111. After this, the transmission/reception unit 101 acquires, from the distribution unit 111, song data corresponding to the song ID received from the user apparatus 12 and transmits the song data to the user apparatus 12 that issued the request.

The user information storage unit 102 is configured using the hard disk drive 23 or a separate database, not shown, and stores information relating to the respective users of the content recommendation system 10.

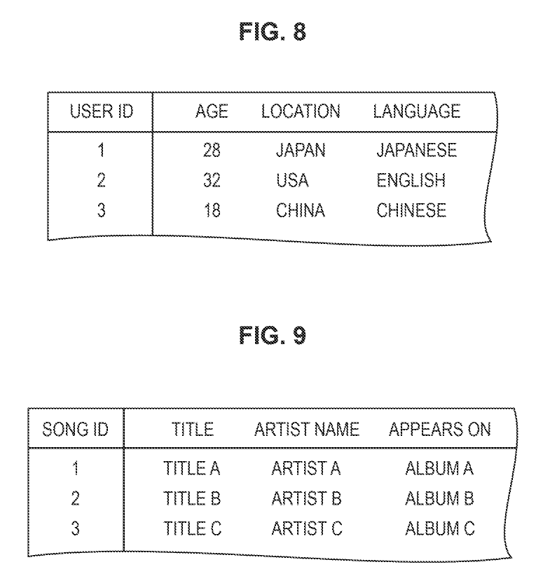

As one example, the user information storage unit 102 stores a user attribute database with the data structure schematically shown in FIG. 8. The user attribute database is a database for managing the attributes of the respective users and associates a user ID and attributes such as age, location, language, and the like together. Note that the data in the user attribute database is capable of being registered from the respective user apparatuses 12.

The song information storage unit 103 is configured using the hard disk drive 23 or a separate database, not shown, and stores information relating to the songs distributed in the content recommendation system 10.

For example, the song information storage unit 103 stores the song IDs and the data of the corresponding songs associated with one another. Note that in cases such as when the same song is recorded on a plurality of albums, a plurality of song data may be present for the same song. In such case, a different song ID is assigned to each incidence of the song data.

As one example, the song information storage unit 103 stores a song information database with the data structure schematically shown in FIG. 9. The song information database is a database for managing information relating to songs to be distributed, with a different database being constructed for each country in which the services of the content recommendation system 10 are provided. The song information database associates each song ID with information relating to the song, such as the song title, artist name, albums the song appears on, and the like.

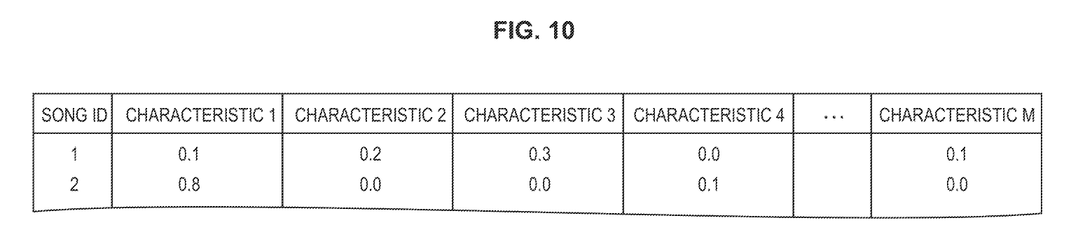

In addition, as one example, the song information storage unit 103 stores a song characteristic database with the data structure schematically shown in FIG. 10, for example. The song characteristic database is a database for managing characteristic values expressing the characteristics of songs. The song characteristic database associates the song IDs with characteristic values for characteristics 1 to M of songs corresponding to the song IDs. As the characteristics 1 to M, as examples, the tempo of the song, the extent to which sounds of a specified frequency are included in the song, the frequency with which a specified keyword is included in the description text of the song, and the like are used. Note that the characteristic values of each song may be manually assigned or may be found by an analysis process carried out by a computer.

Note that a vector that has the characteristic values of the characteristics 1 to M as components and expresses the characteristics of a song is called a “characteristic vector”.

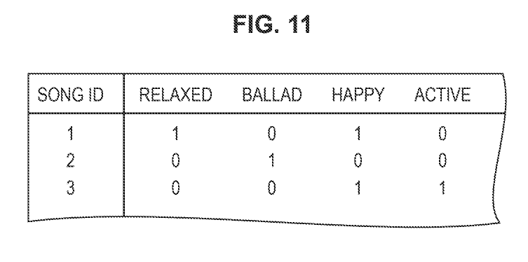

The song information storage unit 103 also stores a song attribute database with the data structure schematically shown in FIG. 11, for example. The song attribute database is a database for managing the attributes of songs. In the song attribute database, the song IDs are associated with flags showing whether the songs corresponding to the song IDs have various attributes. As one example, the song attributes are song moods such as “relaxed”, “ballad”, “happy”, and “active” and are found for example by an analysis process carried out by a computer.

The totaling unit 104 carries out totaling of user evaluation information received from the respective user apparatuses 12 and information relating to recommended song lists transmitted to the user apparatuses 12. The totaling unit 104 includes a totaled information storage unit 104a configured from the hard disk drive 23 or a separate database, not shown, and stores the totaling results in the totaled information storage unit 104a.

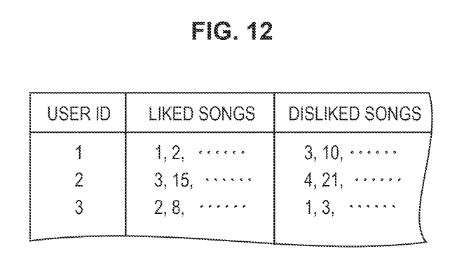

As one example, the totaled information storage unit 104a stores a user evaluation database with the data structure schematically shown in FIG. 12. The user evaluation database is a database that totals the evaluations of songs by each user. In the user evaluation database, the user ID is associated with song IDs of songs for which the user has given a positive evaluation (“liked songs”) and songs for which the user has given a negative evaluation (“disliked songs”).

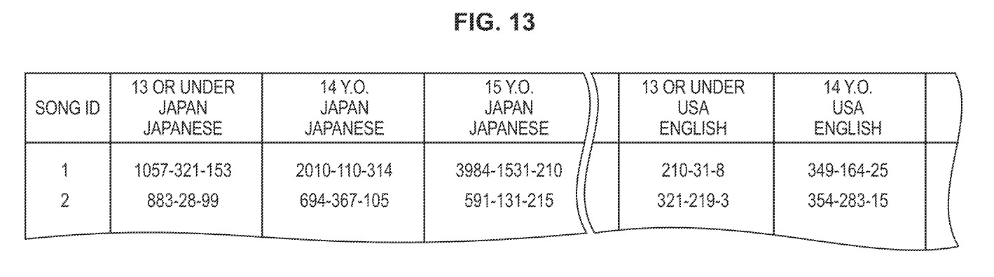

In addition, the totaled information storage unit 104a stores a song evaluation database with the data structure schematically shown in FIG. 13, for example. The song evaluation database is a database in which the evaluations of respective songs are totaled for each user attribute. In the song evaluation database, the song IDs are associated with total values showing evaluations of the songs for each user attribute.

The user attributes are classified according to a combination of age, location, and language, for example. As one example the total values are three values composed of a number of inclusions (x) in a song list transmitted to a user apparatus 12, a number of transmissions (y) of positive evaluations from user apparatuses 12 for the song, and a number of transmissions (z) of negative evaluations from user apparatuses 12 for the song.

The totaling unit 104 also requests the representative song extracting unit 105 to extract representative songs of each artist at specified timing.

As described later, the representative song extracting unit 105 extracts representative songs on a country-by-country basis for each artist based on the song information database in the song information storage unit 103 and the song evaluation database in the totaled information storage unit 104a. The representative song extracting unit 105 registers the extracted representative songs in each country for each artist in the representative song database 106.

The representative song database (DB) 106 is configured using the hard disk drive 23 or a separate database, not shown, and has representative songs in each country for each artist extracted by the representative song extracting unit 105 registered therein.

As described later, the indicated characteristic vector generating unit 121 generates an indicated characteristic vector showing characteristics of songs of an artist indicated by a user based on the song characteristic database in the song information storage unit 103 and the representative song database 106. Alternatively, the indicated characteristic vector generating unit 121 reads characteristic values of a song indicated by the user from the song characteristic database in the song information storage unit 103 to generate the indicated characteristic vector. The indicated characteristic vector generating unit 121 supplies the generated indicated characteristic vector to the vector combining unit 123 and stores the indicated characteristic vector in the vector storage unit 108.

As described later, the user taste vector generating unit 122 uses the song characteristic database in the song information storage unit 103 and the user evaluation database in the totaled information storage unit 104a to generate user taste vectors expressing the characteristics of songs liked by respective users. The user taste vector generating unit 122 also supplies the generated user taste vectors to the vector combining unit 123 and stores the user taste vectors in the vector storage unit 108.

As described later, based on the recommendation ratio indicated by the user, the vector combining unit 123 combines the indicated characteristic vector for an artist or song indicated by the user and the user taste vector of the user to generate a combined vector. The vector combining unit 123 also supplies the generated combined vector to the recommendation unit 109 and stores the combined vector in the vector storage unit 108.

The vector storage unit 108 is configured using the hard disk drive 23 or a separate database, not shown, and stores indicated characteristic vectors, user taste vectors, and combined vectors.

As described later, the recommendation unit 109 generates a recommended song list using the user attribute database in the user information storage unit 102, the song attribute database and the song characteristic database in the song information storage unit 103, the song evaluation database in the totaled information storage unit 104a, the song rankings received from the song ranking distributing server 15, an indicated attribute indicated by the user, and the combined vector generated by the vector combining unit 123. The recommendation unit 109 supplies the generated recommended song list to the representative song inserting unit 110.

If an indicated song has been indicated by the user, the representative song inserting unit 110 investigates the artist of the indicated song based on the song information database in the song information storage unit 103. The representative song inserting unit 110 extracts representative songs of an indicated artist indicated by the user and the artist of an indicated song indicated by the user from the representative song database 106 and inserts the representative songs at or near the top of the recommended song list. The representative song inserting unit 110 supplies the recommended song list after insertion of the representative songs at or near the top to the transmission/reception unit 101.

The distribution unit 111 receives a song ID transmitted from a user apparatus 12 via the communication network 18 and the transmission/reception unit 101. The distribution unit 111 acquires song data related to the received song ID from the song information storage unit 103 and transmits the song data via the transmission/reception unit 101 to the user apparatus 12 that issued the request.

As one example, the display control unit 112 controls the displaying of screens that enable the user apparatus 12 to make use of the services provided by the song distributing server 14. More specifically, the display control unit 112 generates display control data including a display program, data, and the like in accordance with various requests received from the user apparatus 12 via the communication network 18 and the transmission/reception unit 101 and transmits the display control data via the transmission/reception unit 101 to the user apparatus 12. Based on the received display control data, the user apparatus 12 displays a specified screen and/or updates the displaying of a screen.

Note that although the various screens displayed on the user apparatus 12 are divided into screens that are displayed based on display control data supplied from the display control unit 112 of the song distributing server 14 and screens that are displayed by the user apparatus 12 by itself, the classification into such types can be set arbitrarily.

### Example Configuration of Recommendation Unit 109

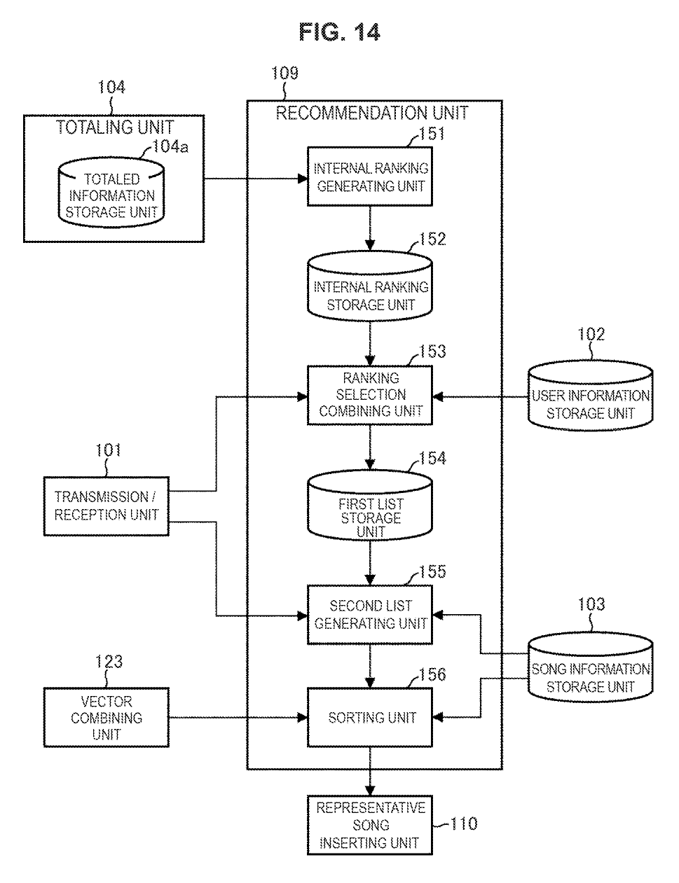

Next, the functional configuration of the recommendation unit 109 of the song distributing server 14 will be described. FIG. 14 is a functional block diagram of the recommendation unit 109.

The recommendation unit 109 functionally includes an internal ranking generating unit 151, an internal ranking storage unit 152, a ranking selection combining unit 153, a first list storage unit 154, a second list generating unit 155, and a sorting unit 156.

Based on the song evaluation database in the totaled information storage unit 104a, the internal ranking generating unit 151 regularly (as examples, weekly or monthly) generates rankings (hereinafter referred to as “internal rankings”) of songs for a range of various user attributes. The internal ranking generating unit 151 stores the generated internal rankings in the internal ranking storage unit 152.

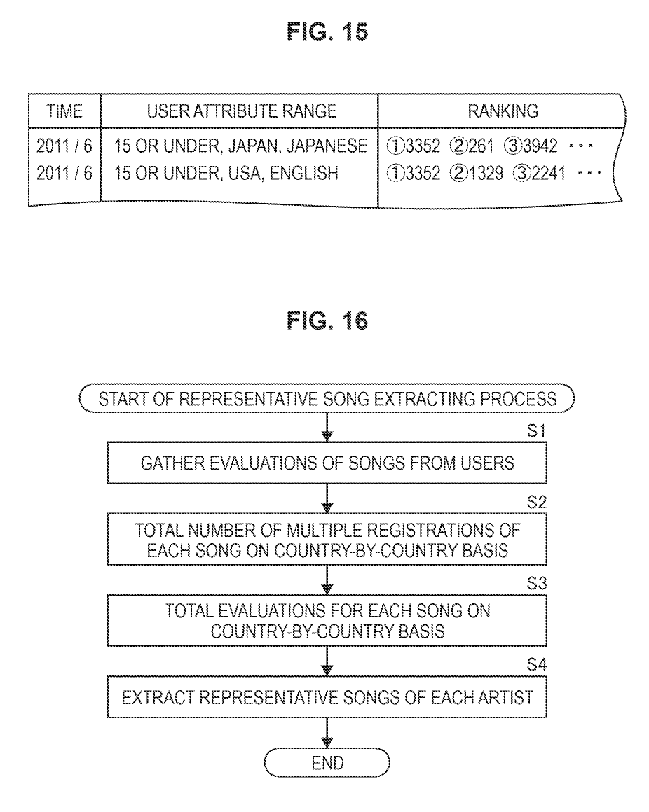

The internal ranking storage unit 152 is configured using the hard disk drive 23 or a separate database, not shown. As shown in FIG. 15, the internal ranking storage unit 152 stores various rankings generated by the internal ranking generating unit 151 in association with the generation time and a range of user attributes.

As one example, the ranking of songs liked by users who are fifteen years old or under, whose location is Japan, and whose language is Japanese is generated by placing the song IDs of a specified number of songs (for example, 100) in descending order of the total number of transmissions y of positive evaluations for each song recorded in the columns “13 or under/Japan/Japanese”, “14 y.o./Japan/Japanese”, and “15 y.o./Japan/Japanese” in the song evaluation database in FIG. 13. At this time, as one example, rankings may be generated by placing the song IDs of a specified number of songs in order of the ratio of the total of y (transmissions of positive evaluations) to the total of x (inclusions in a song list) described above, that is, the ratio of a number of times a positive evaluation has been given relative to the number of inclusions in a recommended song list.

The ranking selection combining unit 153 reads out the user attributes associated with the user ID included in the song list request transmitted from a user apparatus 12 from the user attribute database in the user information storage unit 102. The ranking selection combining unit 153 also reads the internal rankings corresponding to the read out user attributes from the internal ranking storage unit 152. In addition, the ranking selection combining unit 153 receives song rankings (hereinafter referred to as “external rankings”) corresponding to the user attributes via the transmission/reception unit 101 and the communication network 18 from the song ranking distributing server 15. After this, the ranking selection combining unit 153 generates a first list by combining the song IDs included in the acquired two rankings. The ranking selection combining unit 153 stores the generated first list in the first list storage unit 154.

The first list storage unit 154 is configured using the hard disk drive 23 or a separate database, not shown, and stores the first list.

The second list generating unit 155 reads out the first list from the first list storage unit 154. The second list generating unit 155 then narrows down the song IDs included in the first list based on the indicated attribute included in the song list request and the song attribute database in the song information storage unit 103 to generate the second list. The second list generating unit 155 supplies the generated second list to the sorting unit 156.

The sorting unit 156 sorts the song IDs of the second list based on the combined vector supplied from the vector combining unit 123 and the song characteristic database in the song information storage unit 103 to generate the recommended song list. The sorting unit 156 supplies the generated recommended song list to the representative song inserting unit 110.

### Representative Song Extracting Process

Next, a representative song extracting process executed by the content recommendation system 10 will be described with reference to the flowchart in FIG. 16.

In step S1, the song distributing server 14 gathers evaluations for songs from the respective users.

For example, the user is capable, during reproduction of a song, of inputting an evaluation of the song being reproduced using the operation device 36 of the user apparatus 12. If an evaluation has been inputted by the user, the operation unit 61 of the user apparatus 12 transmits user evaluation information showing the song ID of the song being reproduced, the user ID, and the inputted evaluation via the communication interface 38 to the song distributing server 14.

Note that this operation is not limited to songs being reproduced and it may also be possible to select a song not being reproduced, input an evaluation for the selected song, and transmit user evaluation information for such evaluation from the user apparatus 12 to the song distributing server 14.

Also, as one example, if a skip operation has been made for the operation device 36 during reproduction of a song, the operation unit 61 notifies the song reproducing unit 62. In accordance with such notification, the song reproducing unit 62 cancels the reproduction of the song, transmits the next song ID to the song distributing server 14, and reproduces the song data sent in reply. At this time, the operation unit 61 transmits user evaluation information showing the song ID of the song that has been skipped, the user ID, and a negative evaluation via the communication interface 38 to the song distributing server 14.

In addition, as one example, when a song has been reproduced to the end without skipping, the song reproducing unit 62 notifies the operation unit 61. In this case, the operation unit 61 transmits user evaluation information showing the song ID of the song that has been reproduced to the end, the user ID, and a positive evaluation via the communication interface 38 to the song distributing server 14.

The transmission/reception unit 101 of the song distributing server 14 receives the user evaluation information transmitted from the respective user apparatuses 12 via the communication network 18 as described above and supplies the user evaluation information to the totaling unit 104. The totaling unit 104 updates the totaling results stored in the totaled information storage unit 104a based on the acquired user evaluation information.

For example, when the user evaluation information shows a positive evaluation, in the user evaluation database in FIG. 12, the totaling unit 104 adds the song ID shown in the user evaluation information to the liked songs for the user ID shown in the user evaluation information. Meanwhile, when the user evaluation information shows a negative evaluation, in the user evaluation database in FIG. 12, the totaling unit 104 adds the song ID shown in the user evaluation information to the disliked songs for the user ID shown in the user evaluation information.

Also, the totaling unit 104 reads out the attributes of the user corresponding to the user ID shown in the user evaluation information from the user attribute database in the user information storage unit 102. In the song evaluation database in FIG. 13, the totaling unit 104 then updates the totals of the user attribute range to which the user attribute belongs out of the totals for the song ID shown in the user evaluation information. More specifically, if a positive evaluation is shown in the user evaluation information, the totaling unit 104 adds one to the total y of transmissions of positive evaluations, and if a negative evaluation is shown in the user evaluation information, the totaling unit 104 adds one to the total z of transmissions of negative evaluations.

The totaling unit 104 requests the representative song extracting unit 105 to extract representative songs of each artist at specified timing (as examples, at a specified time, at specified intervals, or when a specified amount of user evaluation information has been stored). The processing then proceeds to step S2.

In step S2, the representative song extracting unit 105 totals the number of multiple registrations of each song on a country-by-country basis. More specifically, the representative song extracting unit 105 extracts songs where the combination of title and artist name is the same from the song information database for each country in the song information storage unit 103 and counts the number of times the same combination is registered (hereinafter, the number of “multiple registrations”) for the extracted songs. By doing so, the number of multiple registrations of songs are totaled on a country-by-country basis.

As examples, the representative songs of artists will normally be recorded not only on the original album on which such songs first appear but also multiple times on other albums such as a greatest hits album, a live album, a remastered album, and a compilation album. Accordingly, it can be assumed that there will be many multiple registrations of the representative songs of each artist.

In step S3, the representative song extracting unit 105 totals the evaluations of each song on a country-by-country basis. For example, the representative song extracting unit 105 refers to the song evaluation database in the totaled information storage unit 104a and totals the numbers of the positive evaluations and the negative evaluations for each song on a country-by-country basis. At this time, the representative song extracting unit 105 combines the totaling results for the songs (songs with the same artist and title but with different song IDs) registered multiple times.

In step S4, the representative song extracting unit 105 extracts the representative songs of each artist. More specifically, first the representative song extracting unit 105 selects the artist (hereinafter referred to as the “target artist”) and the country (hereinafter referred to as the “target country”) to be used in the extraction. Next, the representative song extracting unit 105 places the songs of the target artist in order of number of multiple registrations for the target country and, according to a specified standard, assigns points (hereinafter referred to as “registration points”) so that the higher a song is ranked, the higher the points. Accordingly, the greater the number of multiple registrations of a song, the larger the number of registration points assigned to the song.

The representative song extracting unit 105 also places the songs of the target artist in order of number of positive evaluations for the target country or in order of the ratio of positive evaluations and, according to a specified standard, assigns points (hereinafter referred to as “evaluation points”) so that the higher a song is ranked, the higher the points. Accordingly, the greater the number of positive evaluations given to a song that is popular, the larger the number of registration points assigned to the song.

Note that the registration points and the evaluation points are normalized so that the maximum value and/or a standard value are the same, for example.

Next, the representative song extracting unit 105 weights and adds the registration points and the evaluation points to calculate the overall points of each song.

Note that the weights are variable and the values are adjusted according to whether representative songs are being extracted with emphasis on the number of multiple registrations or on user evaluations.

After this, the representative song extracting unit 105 extracts a specified number of songs with high overall points as the representative songs for the target artist in the target country. By doing so, songs that are recorded on a larger number of albums and have been highly evaluated by users are extracted as the representative songs for the target country.

The representative song extracting unit 105 carries out such processing for every artist and for every country. By doing so, the representative songs in each country for each artist are extracted.

The representative song extracting unit 105 then updates the representative songs in each country for each artist that are registered in the representative song database 106.

After this, the representative song extracting process ends.

For example, if representative songs of an artist are extracted manually, it is necessary to assemble a team of evaluators who are informed about music. The chosen songs will also reflect the taste of such evaluators, so there is no guarantee that representative songs will be extracted objectively. In addition, when a number of evaluators are used, there is the risk of the individual evaluators using different evaluation standards. Also, the larger the number of songs, the larger the number of required evaluators and the larger the task of evaluating songs. In addition, the workload of the evaluators increases every time a new song is added.

Although it would be conceivable to extract representative songs based on sales, when extraction is carried out based on album sales, all of the songs included in an album will be extracted as representative songs. Also, when songs are extracted based on sales of singles, songs that were not released as singles are be extracted as representative songs.

Meanwhile, as described earlier, the representative songs of respective artists are normally recorded multiple times on many albums and as a result, such songs become registered multiple times in the song information database. Accordingly, by using the number of multiple registrations in a song information database, it is possible to extract the representative songs of each artist objectively without needing the extraction to be performed manually

However, since it can be envisaged that the number of multiple registrations will be higher for older songs, such as debut songs, if only the number of multiple registrations is used, there will be the risk that the extracted representative songs will be biased toward old songs. Also, for an artist who has released few albums, such as an artist with a short career, there will be no difference in the number of multiple registrations for songs, making it difficult to extract representative songs.

For this reason, by extracting the representative songs using not only the number of multiple registrations but also user evaluations, it is possible to extract the representative songs more accurately in every case. For example, there is a tendency for the number of evaluations given for songs to increase faster for newer songs than for older songs. Accordingly, it becomes possible to extract new songs that are highly popular with users as the representative songs. It also becomes possible to extract representative songs for artists with few album releases for whom there is little difference between songs in the number of multiple registrations.

In addition, by extracting the representative songs for respective countries based on totaling results on a country-by-country basis as described earlier, it is possible to cope with a case where the representative songs differ between countries, such as when different songs have been hits in different countries. It is also possible to cope with a case where the songs that can be distributed differ on a country-by-country basis due to copyright reasons or the like.

Note that as necessary, it is also possible to extract the representative songs using only the registration points (i.e., based on only the number of multiple registrations) and to extract the representative songs using only the evaluation points (i.e., based on only user evaluations).

### Song Recommendation Process

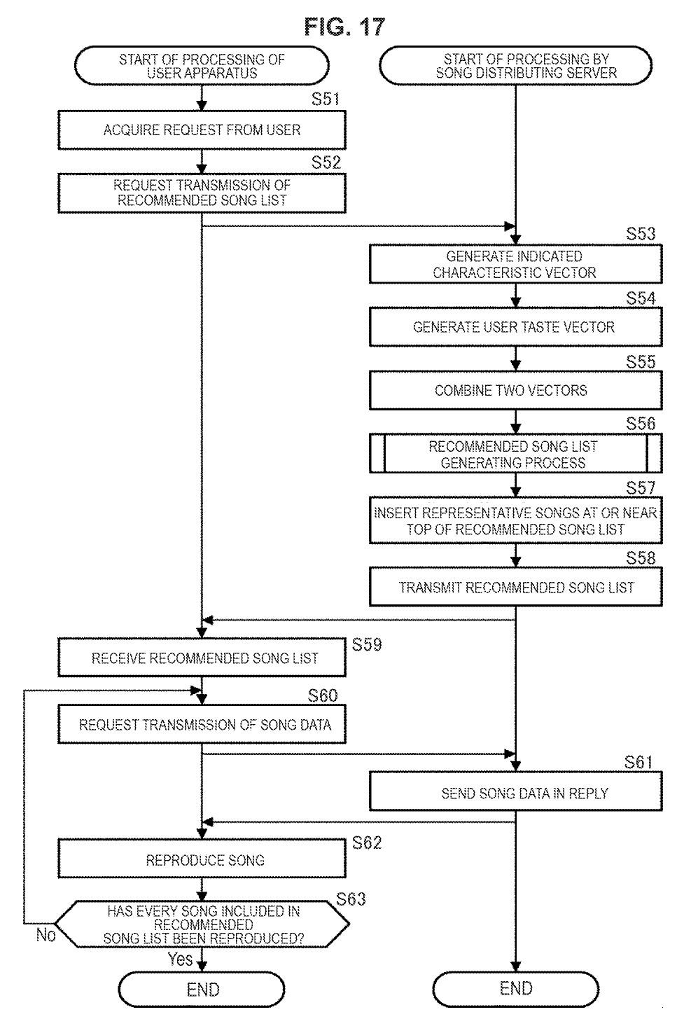

Next, a song recommendation process carried out by the content recommendation system 10 will be described with reference to the flowchart in FIG. 17.

In step S51, a user apparatus 12 acquires a request from a user.

More specifically, if the user wishes to have songs distributed from the song distributing server 14, the user uses the operation device 36 to input a request for the distribution of songs. At this time, the user indicates an attribute (for example, a song mood such as “relaxed”, “ballad”, “happy”, and “active”) of the songs the user wishes to have distributed. Note that it is also possible for the attribute of the songs to be randomly selected by the user apparatus 12 without being indicated by the user.

The user also indicates an artist (indicated artist) or song (indicated song) the user wishes to have distributed.

In addition, the user sets a recommendation ratio for indicating the ratio of songs related to the indicated artist or indicated song to songs that match the user's taste for use when the song distributing server 14 recommends songs.

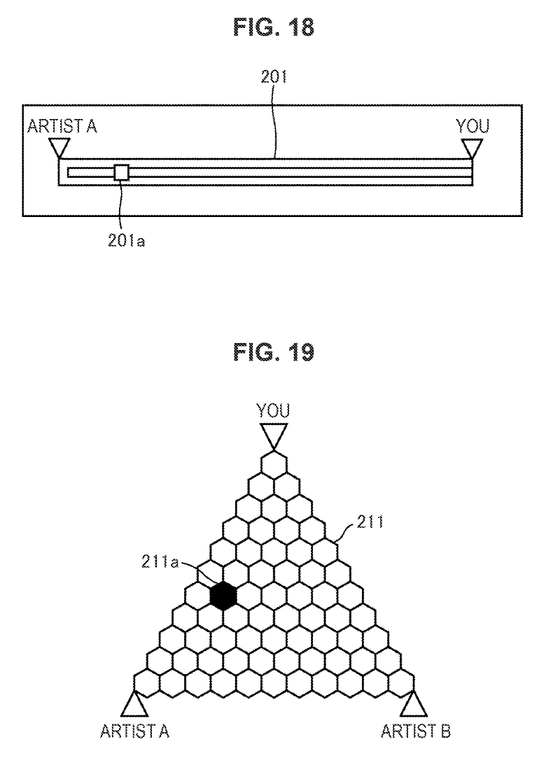

FIG. 18 shows one example of a setting screen for the recommendation ratio. In this setting screen, “Artist A”, which is the name of the indicated artist, is displayed at the left end of a slide bar 201 as a display corresponding to the indicated artist indicated by the user. “You” is displayed at the right end of the slide bar 201 as a display corresponding to the user himself/herself. The recommendation ratio is set based on the distance between the display positions of “Artist A” and “You” and the position of a cursor 201a indicated by the user.

More specifically, the closer the cursor 201a to the “Artist A” side, the higher the recommendation ratio is set for artist A. As a result, a recommended song list that does not strongly reflect the user's taste and has many songs that are typically related to artist A placed at or near the top of the list is distributed.

Meanwhile, the closer the cursor 201a to the “You” side, the higher the recommendation ratio is set for the user's taste. As a result, a recommended song list that does not strongly reflect the characteristics of artist A and has many songs that match the user's taste placed at or near the top of the list is distributed.

Also, the closer the cursor 201a to the midway point between “Artist A” and “You”, the closer the values set for the recommendation ratio for artist A and the recommendation ratio for the user's taste. As a result, a recommended song list which has many songs that are related to artist A and match the user's taste placed at or near the top of the list is distributed.

Here, the expression “songs related to an artist” includes not only songs by the artist in question but also songs by other artists with characteristics that are similar to the songs of the artist in question. As examples, the latter may include songs by artists who have influenced or been influenced by the artist in question, songs by artists with a close relationship to the artist in question, and songs by artists of the same genre as the artist in question.

Also, when a song has been indicated instead of indicating an artist, the title of the indicated song is displayed on the setting screen in FIG. 18 in place of the artist name.

The closer the cursor 201a to the title of the indicated song, the higher the recommendation ratio is set for the indicated song. As a result, a recommended song list that does not strongly reflect the user's taste and normally has many songs related to the indicated song placed at or near the top of the list is distributed.

Meanwhile, the closer the cursor 201a to the “You” side, the higher the recommendation ratio is set for the user's taste. As a result, a recommended song list that does not strongly reflect the characteristics of the indicated song and has many songs that match the user's taste placed at or near the top of the list is distributed.

Also, the closer the cursor 201a to the midway point between the title of the indicated song and “You”, the closer the values set for the recommendation ratio for the indicated song and the recommendation ratio for the user's taste. As a result, a recommended song list which has many songs that are related to the indicated song and match the user's taste placed at or near the top of the list is distributed.

Here, the expression “songs related to the indicated song” includes not only songs by the artist of the indicated song but also songs with characteristics that are similar to the indicated song.

Note that the number of indicated artists or indicated songs is not limited to one and it is also possible to indicate two or more artists, two or more songs, or a combination of songs and artists.

FIG. 19 shows an example of a setting screen for the recommendation ratio in a case where two or more indications of artists and songs are given. Note that FIG. 19 shows an example of a setting screen for the recommendation ratio in a case where two artists are indicated.

In this setting screen, “You” is displayed near the top vertex of a triangular menu 211 as a display corresponding to the user himself/herself. “Artist A” and “Artist B” that are the names of the indicated artists are displayed near the bottom left and bottom right vertices of the menu 211 as displays corresponding to the indicated artists that have been indicated by the user. A recommendation ratio is set based on the distance between the position of a cursor 211a indicated by the user and the respective display positions of “Artist A”, “Artist B”, and “You”.

More specifically, the closer the cursor 211a to “You”, the higher the recommendation ratio is set for the user's taste. Meanwhile, the closer the cursor 211a to “Artist A”, the higher the recommendation ratio is set for artist A, and the closer the cursor 211a to “Artist B”, the higher the recommendation ratio is set for artist B.

Note that the user is also capable of simultaneously indicating an indicated artist and an indicated song. For example, it is possible to indicate artist A and to also indicate a song C of a different artist B to artist A.

The operation unit 61 then acquires a song distribution request inputted by the user.

In step S52, the operation unit 61 requests transmission of a recommended song list. More specifically, the operation unit 61 generates a song list request corresponding to the user request and transmits the song list request via the communication interface 38 to the song distributing server 14. The song list request includes a user ID, at least one of an indicated artist and an indicated song, an indicated attribute, and a recommendation ratio.

In step S53, the song distributing server 14 generates an indicated characteristic vector. More specifically, the transmission/reception unit 101 of the song distributing server 14 receives a song list request from the user apparatus 12 via the communication network 18. The transmission/reception unit 101 then notifies the indicated characteristic vector generating unit 121 of the indicated artist and the indicated song included in the song list request and requests the indicated characteristic vector generating unit 121 to generate an indicated characteristic vector.

On being notified of an indicated artist, the indicated characteristic vector generating unit 121 reads the representative songs of the indicated artist from the representative song database 106. Also, the indicated characteristic vector generating unit 121 reads characteristic values of the read representative songs from the song characteristic database in the song information storage unit 103. The indicated characteristic vector generating unit 121 then generates the indicated characteristic vector for the indicated artist based on the characteristic values of the read representative songs. As one example, the indicated characteristic vector generating unit 121 calculates the average value for each characteristic out of the characteristic values of the read representative songs and generates a vector with the calculated average values as components as an indicated characteristic vector.

Note that it is not necessary to use all of the representative songs of the indicated artist and as one example it is also possible to generate the indicated characteristic vector by selecting a specified number of songs from the representative songs. As another example, it is also possible to generate the indicated characteristic vector by selecting a specified number of songs by the indicated artist at random without being limited to the representative songs. In addition, it is possible for example to generate the indicated characteristic vector using every song by the indicated artist.

Note that as the number of songs used increases, it becomes increasingly likely that an indicated characteristic vector in which the characteristic values of the respective songs are neutralized will be generated, resulting in the risk that the particular characteristics of the artist will no longer be reflected. Accordingly, it is desirable to not use an excessively large number of songs.

On being notified of an indicated song, the indicated characteristic vector generating unit 121 reads the characteristic values of the indicated song from the song characteristic database in the song information storage unit 103. The indicated characteristic vector generating unit 121 then generates a vector with the read characteristic values as components as the indicated characteristic vector.

Note that when a plurality of indicated artists or indicated songs have been indicated, the indicated characteristic vector generating unit 121 generates an indicated characteristic vector for each artist or for each song.

The indicated characteristic vector generating unit 121 supplies the generated indicated characteristic vector(s) to the vector combining unit 123.

Note that it is possible to store the generated indicated characteristic vectors in the vector storage unit 108 and to use the indicated characteristic vectors stored in the vector storage unit 108 the next time the same artist or song is indicated.

In step S54, the song distributing server 14 generates a user taste vector. More specifically, the transmission/reception unit 101 of the song distributing server 14 notifies the user taste vector generating unit 122 of the user ID included in the song list request and requests generation of a user taste vector.

The user taste vector generating unit 122 reads the song IDs of liked songs associated with the notified user ID from the user evaluation database in the totaled information storage unit 104a. The user taste vector generating unit 122 reads characteristic values of the read song IDs from the song characteristic database in the song information storage unit 103. The user taste vector generating unit 122 then uses the same method as when generating the indicated characteristic vectors to generate a user taste vector based on the characteristic values of the read songs. The user taste vector generating unit 122 then supplies the generated user taste vector to the vector combining unit 123.

In step S55, the vector combining unit 123 combines the two types of vectors. More specifically, the vector combining unit 123 acquires a recommendation ratio included in the song list request from the transmission/reception unit 101. After this, the vector combining unit 123 weights and adds the indicated characteristic vector and the user taste vector based on Equation (1) below to generate a combined vector.

Combined vector=|indicated characteristic vector|×w+|user taste vector|×(1.0−w) (1)

Here, w is the weight and is set in a range of 0 to 1 based on the recommendation ratio. Accordingly, the combined vector is a vector where the indicated characteristic vector and the user taste vector are combined with an estimated ratio effectively indicated by the user.

Note that the value of the weight w is set higher the larger the recommendation ratio for the indicated artist or the indicated song, and as a result, the combined vector becomes closer to the indicated characteristic vector. Meanwhile, the value of the weight w is set lower the smaller the recommendation ratio for the indicated artist or the indicated song, and as a result, the combined vector becomes closer to the user taste vector.

Note that when a plurality of indicated artists and indicated songs have been indicated, a weight w is set for every indicated characteristic vector based on the recommendation ratio for the respective indicated artists and indicated songs. The indicated characteristic vectors and the user taste vector are then combined using the respective weights w.

The vector combining unit 123 then supplies the generated combined vector to the recommendation unit 109.

In step S56, the recommendation unit 109 carries out a recommended song list generating process.

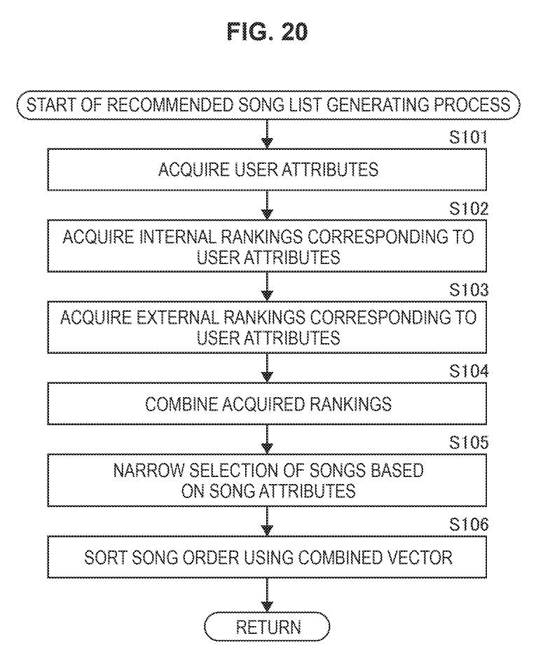

Here, the recommended song list generating process in step S56 will now be described in detail with reference to the flowchart in FIG. 20.

In step S101, the ranking selection combining unit 153 acquires the user attributes. More specifically, the transmission/reception unit 101 notifies the ranking selection combining unit 153 of the user ID included in the song list request and requests combining of rankings. The ranking selection combining unit 153 reads the user attributes corresponding to the notified user ID from the user attribute database in the user information storage unit 102.

In step S102, the ranking selection combining unit 153 acquires internal rankings corresponding to the user attributes. That is, the ranking selection combining unit 153 reads out internal rankings corresponding to a range of user attributes including the read user attributes from the internal ranking storage unit 152. Note that when doing so, internal rankings corresponding to a range adjacent to the range of user attributes of the read internal rankings may also be read out.

In step S103, the ranking selection combining unit 153 acquires the external rankings corresponding to the user attributes. That is, the ranking selection combining unit 153 receives the external rankings corresponding to the read user attributes via the transmission/reception unit 101 and the communication network 18 from the song ranking distributing server 15. For example, the ranking selection combining unit 153 receives the latest rankings for the location (country) of the user or, based on the age of the user, receives rankings issued at such location for a case where the user is fifteen years old.

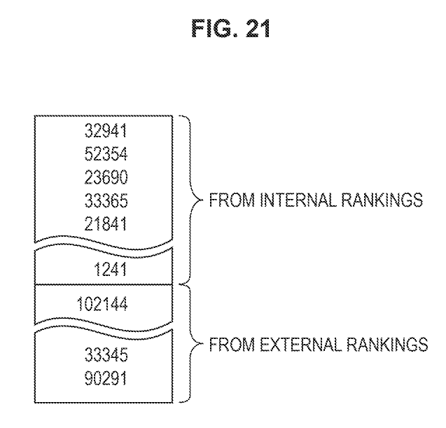

In step S104, the ranking selection combining unit 153 combines the acquired rankings. More specifically, as one example, the ranking selection combining unit 153 generates a list (“first list”) in which the song IDs included in the acquired internal rankings and the song IDs included in the external rankings are combined, as schematically shown in FIG. 21. Note that at this time, it is not necessary for every song ID included in the respective rankings to be included in the first list. The ranking selection combining unit 153 stores the generated first list in the first list storage unit 154.

In step S105, the second list generating unit 155 further narrows the selection of songs based on the attributes of the songs. More specifically, the transmission/reception unit 101 notifies the second list generating unit 155 of the indicated attribute included in the song list request and requests generation of the recommended song list. The second list generating unit 155 reads the first list generated by the ranking selection combining unit 153 from the first list storage unit 154. Also, the second list generating unit 155 reads the song attributes associated with the respective song IDs included in the first list from the song attribute database in the song information storage unit 103. In addition, the second list generating unit 155 extracts the song IDs with the indicated attribute out of the song IDs included in the first list. The second list generating unit 155 then generates a second list composed of the extracted song IDs. The second list generating unit 155 supplies the generated second list to the sorting unit 156.

In step S106, the sorting unit 156 stores the song order using the combined vector. More specifically, the sorting unit 156 reads the characteristic values associated with the song IDs included in the second list from the song characteristic database in the song information storage unit 103. The sorting unit 156 then calculates the similarity between a characteristic vector composed of the characteristic values of a song ID and the combined vector, and sorts the song IDs in the second list in descending order of similarity. By doing so, (song IDs of) songs with characteristics that are similar to the characteristics of songs shown by the combined vector are disposed at or near the top of the second list.

Accordingly, as one example, the closer the weight w in Equation (1) to 1, the more typical songs that are related to the indicated artist or the indicated song are disposed at or near the top of the list irrespective of the user's taste.

Meanwhile, the closer the weight w in Equation (1) to 0, the more songs that match the user's taste are disposed at or near the top of the list irrespective of the indicated artist or the indicated song.

Also, the closer the weight w in Equation (1) to 0.5, the more songs that are related to the indicated artist or the indicated song and match the user's taste are disposed at or near the top of the list.

In addition, the sorting unit 156 adjusts the order of the songs as necessary so that the interval between songs of the same artist is a predetermined number of songs or more. By doing so, it is possible to prevent the song list from becoming monotonous due to songs from the same artist being consecutively played. Also for Internet radio or the like, if there is a restriction such that songs by the same artist are not to be played without an interval of at least a specified number of songs in between, it is possible to satisfy such restriction.

The second list generating unit 155 then supplies the second list after sorting to the representative song inserting unit 110 as the recommended song list.

After this the recommended song list generating process ends.

Returning to FIG. 17, in step S57, the representative song inserting unit 110 inserts the representative songs at or near the top of the recommended song list. More specifically, the representative song inserting unit 110 acquires information showing the indicated artist included in the song list request from the transmission/reception unit 101. The representative song inserting unit 110 also reads the representative songs of the indicated artist from the representative song database 106.

As one example, the representative song inserting unit 110 then rearranges the song order between songs of the indicated artist so that the representative songs of the indicated artist are disposed as close as possible to the top of the recommended song list. For example, if a song A that differs to the representative songs of the indicated artist is disposed above the representative song B, the order of the song A and the representative song B are interchanged.

If there is a representative song that is not included in the recommended song list, the representative song inserting unit 110 also adds (the song ID of) such representative song to the recommended song list. As examples, a representative song is added to the recommended song list by simply inserting (the song ID of) such representative song at or near the top of the recommended song list, replacing a song that is not a representative song of the indicated artist, or replacing a song of another artist.

Note that if an indicated song is included in the song list request, by carrying out the same processing, the indicated song and representative songs of the artist of the indicated song are inserted at or near the top of the recommended song list.

In step S58, the representative song inserting unit 110 transmits the recommended song list via the transmission/reception unit 101 to the user apparatus 12 that issued the request.

At this time, the transmission/reception unit 101 notifies the totaling unit 104 of the song IDs included in the recommended song list and the user ID who is the recipient of the recommended song list. The totaling unit 104 reads the attributes of the user associated with such user ID from the user attribute database in the user information storage unit 102. The totaling unit 104 then adds one to the number of inclusions x in a song list for the user attribute range to which the read attributes belong corresponding to the song IDs in the song evaluation database in the totaled information storage unit 104a.

In step S59, the song reproducing unit 62 of the user apparatus 12 receives the recommended song list via the communication network 18 and the communication interface 38.

In step S60, the song reproducing unit 62 requests transmission of song data. More specifically, the song reproducing unit 62 transmits the highest song ID in the order out of the song IDs of songs yet to be reproduced in the recommended song list via the communication interface 38 to the song distributing server 14.

In step S61, the song distributing server 14 sends the song data in reply. More specifically, the distribution unit 111 of the song distributing server 14 receives the song ID transmitted from the user apparatus 12 via the communication network 18 and the transmission/reception unit 101. The distribution unit 111 acquires the song data associated with the received song ID from the song information storage unit 103 and transmits the song data via the transmission/reception unit 101 to the user apparatus 12 that issued the request.

In step S62, the user apparatus 12 reproduces the song data. More specifically, the song reproducing unit 62 of the user apparatus 12 receives the song data transmitted from the song distributing server 14 via the communication network 18 and the communication interface 38. The song reproducing unit 62 then reproduces the received song data.

In step S63, the song reproducing unit 62 determines whether all of the songs included in the recommended song list have been reproduced. If it is determined that not all of the songs included in the recommended song list have been reproduced, the processing returns to step S60.

After this, the processing in steps S60 to S63 is repeatedly carried out until it is determined in step S63 that all of the songs included in the recommended song list have been reproduced. By doing so, songs corresponding to every song ID included in the recommended song list are reproduced in the song order of the list.

Meanwhile, if it is determined in step S63 that every song included in the recommended song list has been reproduced, processing ends.

Note that after every song included in the recommended song list has been reproduced, it is also possible to return to step S51, and start the processing again from step S51.

As described above, it is possible to recommend songs while giving priority to songs that are similar to at least one of songs of the artist indicated by the user, the song indicated by the user, and songs that the user likes. For example, in addition to songs that match the user's taste, it is possible to indicate an artist or a song that differs to the user's normal taste and immediately recommend songs related to such indicated artist or song.

Also, since songs are recommended while giving priority to representative songs of the indicated artist, it is possible to prevent recommending minor songs by the indicated artist that are not recognized by most people.

In addition, since it is possible to arbitrarily adjust the recommendation ratio, the user is capable of acquiring a recommended song list that gives priority to songs related to the indicated artist or song and is also capable of acquiring a recommended song list that gives priority to songs that match the user's taste.

Also, since information on the indicated artist or song is not reflected in the user taste vector, such indication will not affect the songs recommended to the user thereafter. Accordingly, it is possible for the user to receive pinpoint recommendations of songs that differ to the user's taste and to prevent the undesired recommending of similar songs in the future.

In addition, since the recommended song list is generated based on various types of rankings that vary over time, a situation where the same songs are continuously recommended to users is prevented and a variety of songs can be recommended to the user.

### 2. Modifications

Modifications to the embodiment of the present disclosure will now be described.

### Modification 1

Although an example where recommended songs are extracted based on rankings of songs is described in the above example, it is also possible to extract songs according to another method.

For example, songs may be extracted randomly or songs whose characteristic vectors are similar to the combined vector may be extracted. In the latter case, as one example, it is possible to generate a recommended song list composed of songs that are very similar and provide such list to the user.

Also, the present disclosure may also be applied to simply extracting songs whose characteristic vectors are similar to the combined vector without generating a recommended song list, and recommending such songs to the user.

### Modification 2

Also, as the opposite of the example described above, it is also possible to place songs related to the indicated artist or indicated song at or near the bottom of a recommended song list, or to omit such songs from a recommended song list. As one example, this could be conceivably realized by using a combined vector produced by combining an inverse vector for the indicated characteristic vector and the user taste vector.

### Modification 3

In addition, although an example where representative songs are extracted on a country-by-country basis has been described above, such extraction is not limited to a country-by-country basis. For example, representative songs may be extracted in a region composed of a plurality of countries such as North America, the European Union (EU), or the like, or may be extracted on a regional basis within the same country, such as for the states, counties, prefectures, and regions.

### Modification 4

Also, as one example, it is possible to indicate a person or group related to a song aside from the artist and receive recommendations of songs. Conceivable examples of such person or group include the songwriter, lyricist, arranger, and producer. Also, the expression “person or group” here is not limited to actual people and could conceivably include a corporation or the like such as a record company, a record label, or a music production company.

In such case, as examples, an indicated characteristic vector may be generated and representative songs may be extracted from the songs related to the indicated person or group based on the characteristic values of songs related to the indicated person or group instead of the artist.

### Modification 5

In addition, as one example, each user apparatus 12 may acquire the characteristic vector of each song from the song distributing server 14 and generate the user taste vector at the user apparatus 12. As one example, the user apparatus 12 may then include the user taste vector in a song list request and send such song list request to the song distributing server 14.

### Modification 6

As one example, it is also possible to provide an indicated characteristic vector generated by another apparatus to the song distributing server 14 without having an indicated characteristic vector generated at the song distributing server 14.

### Modification 7

In addition, it is possible to register an artist or song, recommendation ratio, indicated attribute, or the like indicated by the user in the song distributing server 14.

As one example, when the user likes a recommended song list that has been provided, the indicated artist or song, recommendation ratio, and indicated attribute are registered in the song distributing server 14. A user can then use the registered information to easily receive provision of the same recommended song list, even at a different user apparatus 12.

### Modification 8

In addition, means for analyzing the characteristic values of a song may be provided in the song distributing server 14.

### Modification 9

Also, the present disclosure can be applied to a case where various types of content are recommended, such as video like a movie or a television program, a still image such as a photograph or a painting, an electronic book, game, or a document file.

In this case, in the same way as songs, it is possible to indicate a person or group related to such content or to indicate the content itself and receive recommendations of content. Also, the person or group indicated by the user may differ according to the type of content, with conceivable examples being various kinds of artists and writers, such as a movie director, actor, writer, painter, artist, photographer, performer, designer, or creator. The “person or group” is not limited to actual people and could conceivably include a corporation such as a movie studio, a television station, a manufacturer, or a brand.

In addition, in the same way as with songs, it is possible to extract representative works by an indicated person or group based on the number of multiple registrations and user evaluations and to extract representative works using another viewpoint. Also, the characteristic values for the content in use may be changed as appropriate according to the type of content.

The series of processes described above can be executed by hardware but can also be executed by software. When the series of processes is executed by software, a program that constructs such software is installed into a computer. Here, the expression “computer” includes a computer in which dedicated hardware is incorporated and a general-purpose personal computer or the like that is capable of executing various functions when various programs are installed.

It should be noted that the program executed by a computer may be a program that is processed in time series according to the sequence described in this specification or a program that is processed in parallel or at necessary timing such as upon calling.

In the present specification, the expression “system” is assumed to mean an apparatus or collection of apparatuses composed of a plurality of apparatuses, means, or the like.

It should be understood by those skilled in the art that various modifications, combinations, sub-combinations and alterations may occur depending on design requirements and other factors insofar as they are within the scope of the appended claims or the equivalents thereof.

Moreover, the present technology can also be configured as below, for example.

(1)

An information processing apparatus including:

an acquisition unit acquiring information showing at least one of an indicated party, who is a person or group indicated by a user, and indicated content, which is content indicated by the user; and

a recommendation unit recommending, to the user, content that is similar to at least one of content related to the indicated party, the indicated content, and content liked by the user.

(2)

An information processing apparatus according to (1), further including:

a vector combining unit generating a combined vector by combining an indicated characteristic vector, which is a characteristic vector showing characteristics of the content related to the indicated party or the indicated content, and a user taste vector, which shows characteristics of the content liked by the user,

wherein the recommendation unit recommends, to the user, content whose characteristic vector is similar to the combined vector.

(3)

An information processing apparatus according to (2),

wherein the vector combining unit combines the indicated characteristic vector and the user taste vector using a ratio indicated by the user.

(4)

An information processing apparatus according to (3), further including:

a display control unit controlling display of a setting screen which displays, when the user has made a total of at least two indications of indicated parties and/or indicated content, displays respectively corresponding to the indicated parties and/or the indicated content and a display corresponding to the user at specified display positions and which sets a ratio for use when combining the indicated characteristic vector and the user taste vector, based on distances from the respective display positions to a position indicated by the user.

(5)

An information processing apparatus according to (3), further including:

a display control unit operable, when the indicated party has been indicated, to carry out control to display a name of the indicated party in a setting screen setting the ratio for use when combining the indicated characteristic vector and the user taste vector,

wherein the vector combining unit combines the indicated characteristic vector showing the characteristics of the content related to the indicated party and the user taste vector using the ratio set in the setting screen.

(6)

An information processing apparatus according to any of (2) to (5), further including:

an indicated characteristic vector generating unit generating the indicated characteristic vector; and

a user taste vector generating unit generating the user taste vector.

(7)

An information processing apparatus according to (6), further including:

a representative work extracting unit extracting a representative work out of the content related to the indicated party based on at least one of the number of multiple registrations of content and user evaluations of content,

wherein the indicated characteristic vector generating unit generates the indicated characteristic vector for the indicated party based on a characteristic vector of the extracted representative work.

(8)

An information processing apparatus according to any of (2) to (7),

wherein the recommendation unit generates a list of content recommended to the user and sets an order of content in the list based on similarity between the combined vector and respective characteristic vectors of the content.

(9)

An information processing apparatus according to any of (1) to (6),

wherein the recommendation unit generates a list of content recommended to the user, and

the information processing apparatus further includes

a representative work extracting unit extracting a representative work out of content related to one of the indicated party and a person or group related to the indicated content, based on at least one of the number of multiple registrations of content and user evaluations of content; and

a representative work inserting unit inserting the extracted representative work at or near the top of the list.

(10)

An information processing apparatus according to (7) or (9),

wherein the representative work extracting unit extracts the representative work separately for specified regions.

(11)

An information processing method carried out by an information processing apparatus that recommends content, including:

acquiring information showing at least one of an indicated party, who is a person or group indicated by a user, and indicated content, which is content indicated by the user; and

recommending, to the user, content that is similar to at least one of content related to the indicated party, the indicated content, and content liked by the user.

(12)

A program causing a computer to execute processing including:

acquiring information showing at least one of an indicated party, who is a person or group indicated by a user, and indicated content, which is content indicated by the user; and

recommending, to the user, content that is similar to at least one of content related to the indicated party, the indicated content, and content liked by the user.

(13)

An information processing system including a server and a client,

wherein the client includes a transmission unit transmitting information showing at least one of an indicated party, who is a person or group indicated by a user, and indicated content, which is content indicated by the user; and

the server includes

a reception unit receiving the information transmitted from the client; and

a recommendation unit recommending, to the user, content that is similar to at least one of content related to the indicated party, the indicated content, and content liked by the user.

(14)

An information processing method including:

a client transmitting information showing at least one of an indicated party, who is a person or group indicated by a user, and indicated content, which is content indicated by the user; and

a server receiving the information transmitted from the client and recommending, to the user, content that is similar to at least one of content related to the indicated party, the indicated content, and content liked by the user.

The present disclosure contains subject matter related to that disclosed in Japanese Priority Patent Application JP 2011-159543 filed in the Japan Patent Office on Jul. 21, 2011, the entire content of which is hereby incorporated by reference.

What is claimed is:

1. An information processing apparatus comprising:
an acquisition unit acquiring information showing at least one of an indicated party, who is a person or group indicated by a user, and indicated content, which is content indicated by the user; and
a recommendation unit recommending, to the user, content that is similar to at least one of content related to the indicated party, the indicated content, and content liked by the user.

2. An information processing apparatus according to claim 1, further comprising:
a vector combining unit generating a combined vector by combining an indicated characteristic vector, which is a characteristic vector showing characteristics of the content related to the indicated party or the indicated content, and a user taste vector, which shows characteristics of the content liked by the user,
wherein the recommendation unit recommends, to the user, content whose characteristic vector is similar to the combined vector.

3. An information processing apparatus according to claim 2,
wherein the vector combining unit combines the indicated characteristic vector and the user taste vector using a ratio indicated by the user.

4. An information processing apparatus according to claim 3, further comprising:
a display control unit controlling display of a setting screen which displays, when the user has made a total of at least two indications of indicated parties and/or indicated content, displays respectively corresponding to the indicated parties and/or the indicated content and a display corresponding to the user at specified display positions and which sets a ratio for use when combining the indicated characteristic vector and the user taste vector, based on distances from the respective display positions to a position indicated by the user.

5. An information processing apparatus according to claim 3, further comprising:
a display control unit operable, when the indicated party has been indicated, to carry out control to display a name of the indicated party in a setting screen setting the ratio for use when combining the indicated characteristic vector and the user taste vector,
wherein the vector combining unit combines the indicated characteristic vector showing the characteristics of the content related to the indicated party and the user taste vector using the ratio set in the setting screen.

6. An information processing apparatus according to claim 2, further comprising:
an indicated characteristic vector generating unit generating the indicated characteristic vector; and
a user taste vector generating unit generating the user taste vector.

7. An information processing apparatus according to claim 6, further comprising:
a representative work extracting unit extracting a representative work out of the content related to the indicated party based on at least one of the number of multiple registrations of content and user evaluations of content,
wherein the indicated characteristic vector generating unit generates the indicated characteristic vector for the indicated party based on a characteristic vector of the extracted representative work.

8. An information processing apparatus according to claim 2,
wherein the recommendation unit generates a list of content recommended to the user and sets an order of content in the list based on similarity between the combined vector and respective characteristic vectors of the content.

9. An information processing apparatus according to claim 1,
wherein the recommendation unit generates a list of content recommended to the user, and
the information processing apparatus further includes
a representative work extracting unit extracting a representative work out of content related to one of the indicated party and a person or group related to the indicated content, based on at least one of the number of multiple registrations of content and user evaluations of content; and
a representative work inserting unit inserting the extracted representative work at or near the top of the list.

10. An information processing apparatus according to claim 9,
wherein the representative work extracting unit extracts the representative work separately for specified regions.

11. An information processing method carried out by an information processing apparatus that recommends content, comprising:
acquiring information showing at least one of an indicated party, who is a person or group indicated by a user, and indicated content, which is content indicated by the user; and
recommending, to the user, content that is similar to at least one of content related to the indicated party, the indicated content, and content liked by the user.

12. A program causing a computer to execute processing comprising:
acquiring information showing at least one of an indicated party, who is a person or group indicated by a user, and indicated content, which is content indicated by the user; and
recommending, to the user, content that is similar to at least one of content related to the indicated party, the indicated content, and content liked by the user.

13. An information processing system including a server and a client,
wherein the client includes a transmission unit transmitting information showing at least one of an indicated party, who is a person or group indicated by a user, and indicated content, which is content indicated by the user; and
the server includes
a reception unit receiving the information transmitted from the client; and
a recommendation unit recommending, to the user, content that is similar to at least one of content related to the indicated party, the indicated content, and content liked by the user.

14. An information processing method comprising:
a client transmitting information showing at least one of an indicated party, who is a person or group indicated by a user, and indicated content, which is content indicated by the user; and
a server receiving the information transmitted from the client and recommending, to the user, content that is similar to at least one of content related to the indicated party, the indicated content, and content liked by the user.
